(19) United States
(12) Patent Application Publication
(10) Pub. No.: US 2025/0241277 A1
(43) Pub. Date: Jul. 31, 2025

(54) DETACHABLE BIRD FEEDER

(71) Applicant: Jianxin Zhong, Shantou City (CN)

(72) Inventor: Jianxin Zhong, Shantou City (CN)

(21) Appl. No.: 18/609,766

(22) Filed: Mar. 19, 2024

(30) Foreign Application Priority Data
Jan. 25, 2024 (CN) 202410110400.1

(51) Int. Cl. A01K 39/04

(52) U.S. Cl. CPC A01K 39/04

(57) ABSTRACT

A detachable bird feeder is provided. The detachable bird feeder includes a shading assembly, a carrier and a substantially U-shaped connector. The connector includes opposite horizontal sides and vertical side connecting the horizontal sides, the horizontal sides serve as a top and a bottom of the connector respectively, the vertical side is used for supporting and fixing. The detachable bird feeder includes a first state for unfolding and a second state for storage, in the first state, the shielding assembly and the carrier are respectively connected to a top and a bottom of the connector, and there is an open space between the shielding assembly and the carrier; in the second state, the shielding assembly and the carrier both are detached and stacked with the connector.

### FIELD OF THE INVENTION

The present invention relates to a bird feeder field, especially to a detachable bird feeder.

### BACKGROUND OF THE INVENTION

Birds are higher vertebrates adapted to land and air life. Some beneficial birds can eliminate pests and rodents, protect crops and trees, such as swallows and owls, and some birds can be used for viewing. To protect the ecological environment, we should cherish beneficial birds; but in the current situation of accelerating urbanization, the ecological environment is inevitably squeezed or even destroyed, and many birds have lost their habitats. In order to protect the survival of birds, people usually set up bird feeders to provide food for birds and reduce their survival pressure.

In order to provide better protection for the food in the bird feeder and the birds those come to eat, a bird feeder with a window structure has emerged on the market. It can be fixed to smooth objects such as window glass through a suction cup structure. However, this type of bird feeder is usually an integral triangular house structure, usually with an obtuse angle design of integral eaves covering structure and a movable feed tray. Due to the unique appearance of the house, it is difficult to modify it into a detachable structure, which results in most of the space occupied by this type of bird feeder being empty during storage, occupying a large amount of storage space and reducing space utilization. This significantly increases warehousing and logistics costs, and significantly reduces logistics transportation efficiency.

### SUMMARY OF THE INVENTION

### (1) Solved Technical Problem

To solve the above problems, the present invention provides a detachable bird feeder, which can provide shade and rain protection after assembly and is easy to store after disassembly.

### (2) Technical Solution

To achieve the above objectives, the present invention provides the following technical solution:

The detachable bird feeder includes a shading assembly, a carrier and a substantially U-shaped connector. The connector includes opposite horizontal sides and vertical side connecting the horizontal sides, the horizontal sides serve as a top and a bottom of the connector respectively, the vertical side is used for supporting and fixing. The detachable bird feeder includes a first state for unfolding and a second state for storage, in the first state, the shielding assembly and the carrier are respectively connected to a top and a bottom of the connector, and there is an open space between the shielding assembly and the carrier; in the second state, the shielding assembly and the carrier are both detached and stacked with the connector.

In a preferred embodiment, the vertical side is equipped with multiple connecting parts including gourd holes with upper dimensions smaller than lower dimensions, and being used for connecting other objects.

In a preferred embodiment, the top of the connector is equipped with two opposite slots, and the shielding assembly comprises: two connecting portions respectively connected in the two slots with damping sliding, so that the relative positions of the connecting portions and the connector are fixed without external force; and two covers fixedly connected to the two connecting portions and extend in a direction away from the slots, so that the two covers can form an eaves shape when matched with the top of the connector, thereby shielding the carrier.

In a preferred embodiment, the slot is located at the top of the connector, and extends from one end away from the vertical side of the connector at the top to one end close to the vertical side of the connector, one end of the slot has an opening located on the vertical side of the connector and is used in conjunction with an object for fixing the connector to restrict the connecting portions within the slot.

In a preferred embodiment, at least one of the connecting portions and the connector have elasticity, and one side of the connecting portions is bent into a V-shape, the thickness of the V-shaped part of the connecting portions gradually increases from the insertion end to the opposite end, so that the resistance generated by the connecting portions during insertion into the slot gradually increases, thereby clamping the connecting portions and the connector tightly.

In a preferred embodiment, the detachable bird feeder further includes a limiting assembly, the limiting assembly is formed on the connector, the bottom of the carrier is equipped with a limiting slot, the limiting assembly is matched with the limiting slot to limit the movement of the carrier, thereby fixing the relative position between the connector and the carrier.

In a preferred embodiment, the limiting assembly includes: a first limiting portion, the first limiting portion is located at the bottom of the connector and is vertically arranged, the first limiting portion is connected to the limiting slot with a damping sliding connection to limit the movement of the carrier; a second limiting portion, the second limiting portion is located on the vertical side of the connector and is horizontally arranged, a distance between the second limiting portion and the bottom of the connector is the same as the thickness of the carrier, preventing the carrier from tilting or overturning when subjected to downward force; and a third limiting portion, the third limiting portion is located at a front end of the bottom of the connector and corresponds to the carrier, the third limiting portion is configured for limiting the forward movement of the carrier; the first limiting portion, the second limiting portion, and the third limiting portion in a combination can prevent the carrier from being misaligned or detached from the connector when subjected to downward force.

In a preferred embodiment, the third limiting portion is equipped with a snapping joint, and the carrier is equipped with a corresponding snapping slot, at least one of the third limiting portion, the snapping joint, the carrier, and the snapping slot is elastic, so that the third limiting portion and the carrier can be elastically connected by the combination of the snapping joint and the snapping slot for buckle connection, the bottom of the snapping joint and the snapping slot are both horizontally arranged, to ensure that the carrier does not misalign or detach from the connector when subjected to upward force.

In a preferred embodiment, the carrier is equipped with a partition plate to divide the carrier into multiple areas.

In a preferred embodiment, the bottom of the carrier is equipped with multiple through holes, which circulate with the external air and are used to discharge liquid.

In a preferred embodiment, a length of the carrier is less than or substantially equal to a height of the vertical side of the connector.

### (3) Beneficial Effects

Compared with the prior art, the present invention brings the following beneficial effects:

In actual use, the connector is placed or fixed in a designated position, and then a shading assembly for shading and rain blocking is installed at its top, and a carrier for carrying bird and feeding bird is installed at its bottom to complete the assembly of the detachable bird feeder and present it in its unfolding first state. At the first state, the vertical side is equivalent to the wall, the shading assembly is equivalent to the roof and eaves, and the carrier is equivalent to the floor, the open space between the shading assembly and the carrier is equivalent to a window, allowing the assembly of the connector, shading assembly, and carrier to form a house shape with a window structure.

After use, the shading assembly and the carrier can be detached from the connector and stacked together, presenting the detachable bird feeder in its second state for storage, saving storage space occupied by the open space mentioned above. At the second state, the volume is smaller, and the utilization rate of storage space is higher. Especially during mass production, the same components can be stacked together, allowing for the storage or transportation of more detachable bird feeders in the same space. This significantly reduces storage and logistics costs, and improves logistics transportation efficiency. In general, the detachable bird feeder in the present invention can provide shade and rain protection after assembly, and is easy for storage after disassembly.

### BRIEF DESCRIPTION OF THE DRAWINGS

FIG. 1 is a schematic structural view of an unfolding first state of a detachable bird feeder according to an embodiment of present invention.

FIG. 2 is another schematic structural view of an unfolding first state of a detachable bird feeder according to an embodiment of present invention.

FIG. 3 is an exploded schematic structural view of the detachable bird feeder of the present invention.

FIG. 4 is a reversed partially enlarged view of the shading assembly of the detachable bird feeder of FIG. 3.

FIG. 5 shows the connector of the detachable bird feeder of FIG. 1.

FIG. 6 shows the enlarged view of part A of FIG. 5.

FIG. 7 is a schematic structural view of the carrier of detachable bird feeder of FIG. 1.

FIG. 8 shows the enlarged view of part B of FIG. 7.

FIG. 9 is a schematic structural view of a second state for storage of a detachable bird feeder according to an embodiment of present invention.

FIG. 10 is another schematic structural view of a second state for storage of a detachable bird feeder according to an embodiment of present invention.

FIG. 11 shows a plurality of detachable bird feeders stacked in the second state.

FIG. 12 shows a plurality of connectors stacked for storage.

FIG. 13 shows a plurality of covers stacked for storage.

FIG. 14 shows a plurality of carriers stacked for storage.

Labels in the drawing: 1, connector; 101, top; 102, bottom; 103, vertical side; 2, shading assembly; 21, connecting portion; 211, V-shaped part; 211A, insertion end; 211B, opposite end; 22, cover; 3, carrier; 4, connecting part; 5, slot; 51, opening; 6, limiting assembly; 61, first limiting portion; 62, second limiting portion; 63, third limiting portion; 7, liming slot; 8, snapping joint; 9, snapping slot; 10, partition plate; 11, through hole; 12, edge handle

### DETAILED DESCRIPTION OF PREFERRED EMBODIMENTS

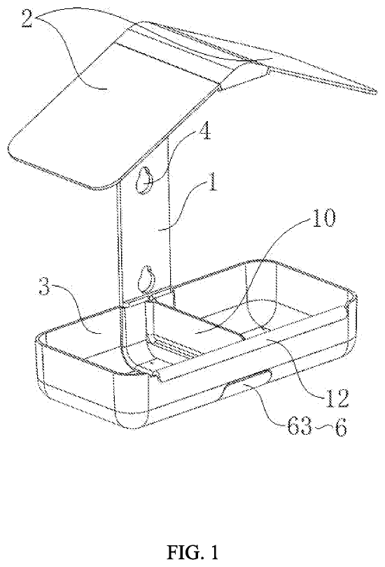

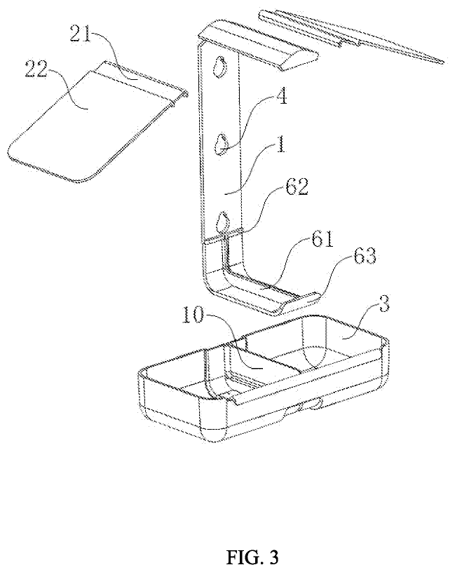

Referring to FIGS. 1-3, a detachable bird feeder according to an embodiment is provided. The detachable bird feeder includes a connector 1, a shading assembly 2 and a carrier 3. The shading assembly 2 and the carrier 3 can be detachably connected to the connector 1.

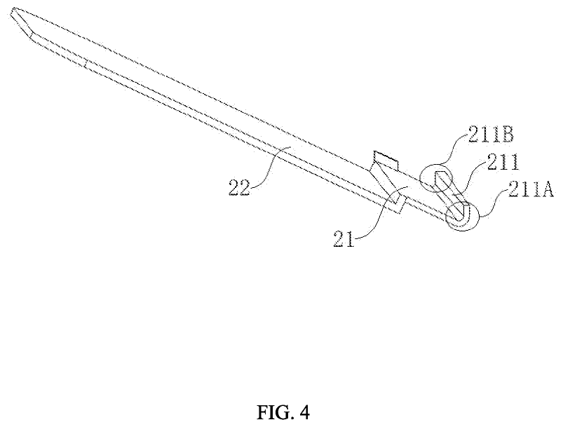

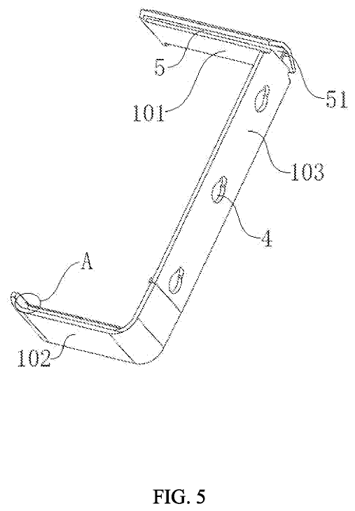

Further referring to FIGS. 4-5, the connector 1 is substantially U-shaped. The two opposite sides of connector 1 are horizontally arranged and respectively serve as the top 101 and bottom 102 of connector 1, and the other side connecting the top 101 and the bottom 102 is the vertical side 103. In actual use, place or fix the connector 1 in a designated position, then install the shading assembly 2 at the top 101 of the connector 1, and install the carrier 3 at its bottom 102 of the connector 1 to complete the assembly of the detachable bird feeder to present it in its first state, i.e., unfolding state.

At the first state, the vertical side 103 of the connector 1 is equivalent to a wall, the shading assembly 2 is equivalent to a roof and eaves, and the carrier 3 is equivalent to the floor, the open space between shading assembly 2 and carrier 3 is equivalent to a window, allowing the assembly of connector 1, shading assembly 2 and carrier 3 to form a house shape with a window structure.

The shading assembly 2 provides shade and rain protection, the carrier 3 is used for loading and feeding. The specific structure of the carrier 3 is not limited in the present invention. In order to prevent food from falling off the carrier 3, the carrier 3 in this embodiment uses a tray with an edge, and a top of the carrier 3 is open.

Through the design of the above structure, it is more convenient to disassemble and assemble the shading assembly 2 and the carrier 3. Additionally, since the opposite sides of the U-shaped connector 1 are horizontally arranged and serve as the top 101 and bottom 102 of the connector 1, the shading assembly 2 and the carrier 3 are also supported by the connector 1, making them more stable and secure after installation, and less prone to shaking and misalignment.

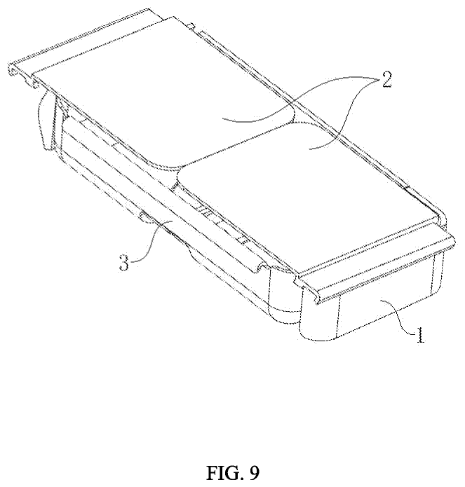

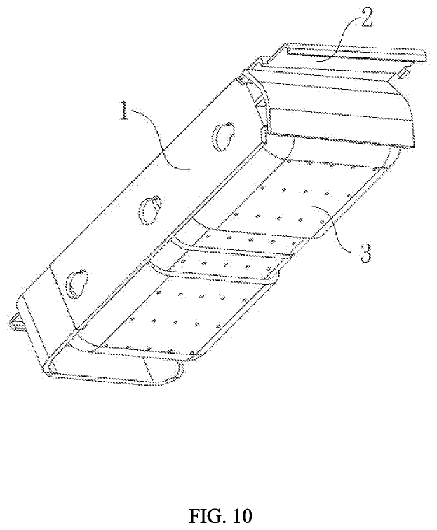

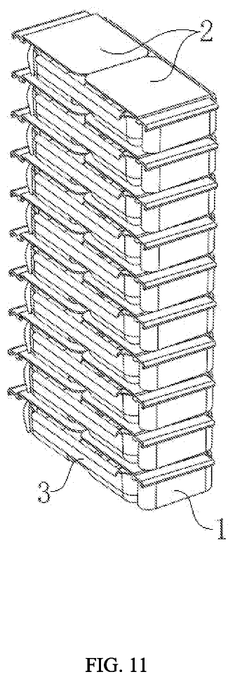

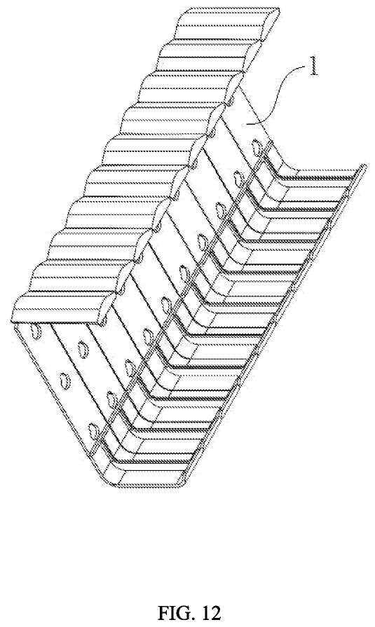

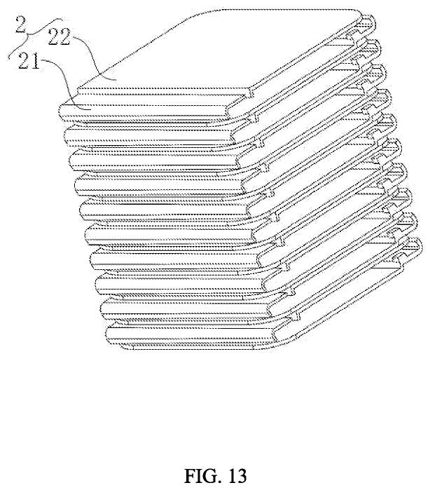

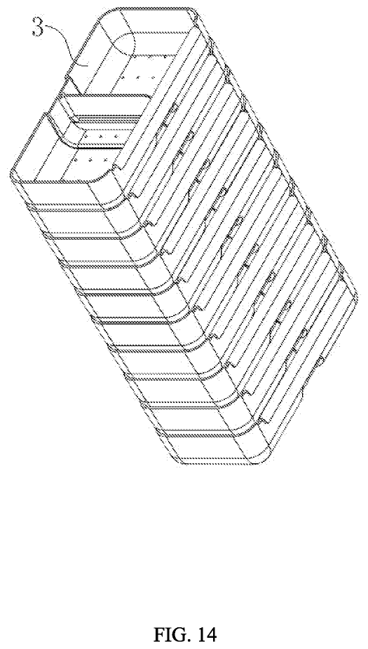

After use, the shading assembly 2 and the carrier 3 can be removed from the connector 1 and stacked together, so that the detachable bird feeder presents a second state for storage, as shown in FIGS. 9 and 10, which can save the storage space occupied by the open space mentioned above. In this way, the volume is smaller and the space utilization rate is higher; especially during mass production, the same components can be stacked and placed together, as shown in FIGS. 12 to 14. Within a same space, more detachable bird feeders can be stored or transported at once, as shown in FIG. 11, storage and logistics costs are significantly reduced, and logistics transportation efficiency is significantly improved.

Referring again to FIGS. 9 and 10, after disassembly, the connector 1 can be changed from vertically placed to horizontally placed, eliminating the open space between the shading assembly 2 and the carrier 3, thus reducing the storage space occupied by the detachable bird feeder. Furthermore, when the carrier 3 is in the form of a tray, and the inner dimensions of the carrier 3 are larger than those of the connector 1 and shading assembly 2, so that the connector 1 and shading assembly 2 can be directly stored in the carrier 3, which saves more space during storage. In this way, after removing the shading assembly 2 and the carrier 3 from the connector 1, they can be stored together, reducing the volume of the entire detachable bird feeder.

The vertical side 103 of the connector 1 is equipped with multiple connecting parts 4 for connecting other objects. There are various structures that can connect two objects, and one of them is introduced in this embodiment, specifically, the connecting part 4 can be a gourd hole with an upper size smaller than the lower size, used for hooking or fitting with fixing components to fix and connect to other objects.

Through the design of the above structure, nail shaped structures with protruding ends can be installed in places where birds often inhabit, such as walls or large trees. At this time, the detachable bird feeder can be hooked onto the protruding structures through the gourd hole shaped connecting parts 4, so that it will be obstructed by the protruding structures when moving horizontally and will not fall, making it convenient and fast to pick and place. In addition, due to the multiple connecting parts 4, therefore, the effect of multi-point fixation can be achieved, and two points can fix an object in a certain position. Therefore, when a bird stands at a certain point on the carrier 3, causing uneven overall force on the detachable bird feeder, it will not drive the detachable bird feeder to tilt or move.

There are various structures that can make the connector 1 and shading assembly 2 detachable. This embodiment introduces one of them. Specifically, the top 101 of the connector 1 is equipped with two opposite slots 5, and the shading assembly 2 includes two connecting portions 21 and two covers 22. The two connecting portions 21 are respectively connected with damping sliding in two slots 5, so that the relative positions of the connecting portions 21 and the connector 1 are fixed without external force influence. The two covers 22 are fixedly connected to the two connecting portions 21 respectively, and extend in a direction away from the respective slots 5, so that the two covers 22 can form eaves shape with the top 101 of connector 1, thereby shading the carrier 3. Through the design of the above structure, the two covers 22 can be placed opposite each other on the left and right sides of the connector 1, forming a structure similar to the roof or eaves, thereby providing shade and rain protection.

Furthermore, based on the above scheme, two slots 5 can be tilted so that after the shading assembly 2 is connected to the connector 1, the angle between the two covers 22 facing downwards is obtuse. At this time, the two tilted covers 22 can form a triangular structure, which is more stable and conducive to the flow of rainwater.

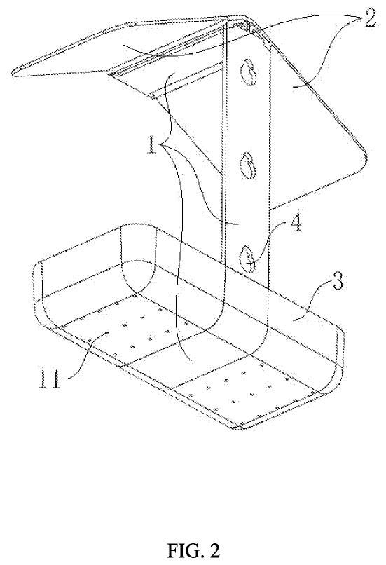

Referring to FIGS. 2 and 5, the present invention does not specify the specific position and opening direction of the slot 5. However, depending on the set position and opening direction, the stability of the shading assembly 2 detachably connected to the connector 1 through insertion is also different. In order to enhance the stability of the shading assembly 2 after installation, the following design is carried out in this embodiment: the slot 5 is located at the top 101 of connector 1 and extends from one end away from the vertical side 103 of connector 1 to one end close to the vertical side 103 of connector 1. One end of slot 5 has an opening 51 located on the vertical side 103 of connector 1, which in conjunction with an object used to fix the connector 1, can limit the connecting portion 21 within slot 5.

Through the design of the above structure, after the connector 1 is fixed on the object, the vertical side 103 will adhere to the object. As the opening 51 of slot 5 is located on the vertical side 103 of connector 1, the object can block the opening of slot 5, thereby limiting the connecting portion 21 to the slot 5, making the shading assembly 2 more stable and firm after installation, and not falling off from the connector 1.

Referring to FIG. 4, in order to make the insertion connection between the connecting portion 21 and the connector 1 more secure, the following design has been carried out in this embodiment. Specifically, at least one of the connecting portion 21 and the connector 1 is elastic, and one side of the connecting portion 21 is bent into a V-shape. The thickness of the V-shaped part 211 of the connecting portion 21 gradually increases from the insertion end 211A to the opposite end 211B, so that the damping generated by connecting portion 21 during insertion into the slot 5 gradually increases, so as to tighten the connecting portion 21 and the connector 1.

Through the design of the above structure, the deformation of the connecting portion 21 with the V-shaped part 211 will increase as it is continuously inserted into the slot 5. The elasticity deformation generated by the connecting portion 21 and the pressure generated by the connecting portion 21 and the connector 1 at slot 5 will also increase, resulting in greater damping during the movement of the connecting portion 21, this allows the connecting portion 21 to firmly clamp into slot 5 on the connector 1 without external force.

Furthermore, it is possible to gradually increase the angle between the V-shaped part 211 of the connecting portion 21 from the insertion end 211A to the opposite end 211B, which can also increase the damping generated by the connecting portion 21 during insertion into the slot 5, thereby clamping the connecting portion 21 and the connector 1.

During use, bird feeders are usually only subjected to horizontal and vertical downward forces. However, the storage containers in bird feeders on the market are usually directly fixed and connected to the bird feeder. Although they are sturdy, they are not easy to disassemble and place. In order to design a carrier 3 that is easy to disassemble and place based on the actual force situation of the bird feeder in use, the following design is carried out in this embodiment. Specifically, a limiting assembly 6 is provided, the limiting assembly 6 is installed on the connector 1 to restrict the movement of the carrier 3, thereby fixing the relative position between the connector 1 and the carrier 3.

The bottom of the carrier 3 is equipped with a limiting slot 7 located in the vertical plane. The limiting assembly 6 includes a first limiting portion 61, a second limiting portion 62, and a third limiting portion 63. The first limiting portion 61 is located at the bottom 102 of connector 1 and is vertically arranged. The first limiting portion 61 is connected to the limiting slot 7 with damping sliding, thus to restrict the movement of carrier 3. The second limiting portion 62 is located on the vertical side 103 of the connector 1 and is horizontally arranged. The distance between the second limiting portion 62 and the bottom 102 of the connector 1 is the same as the thickness of the carrier 3, to prevent the carrier 3 from tilting or overturning when subjected to downward force. The third limiting portion 63 is located at the front end of the bottom 102 of the connector 1 and corresponds to the carrier 3 to limit the forward movement of the carrier 3. The first limiting portion 61, the second limiting portion 62, and the third limiting portion 63 in a combination can prevent the carrier 3 from being misaligned or detached from the connector 1 when subjected to downward force.

Through the design of the above structure, when the carrier 3 moves forward, it will be limited by the third limiting portion 63. When the carrier 3 moves backward, it will be limited by the vertical side 103 of connector 1. When the carrier 3 moves left or right, it will be limited by the first limiting portion 61. When the carrier 3 tilts up due to uneven force, it will be limited by the second limiting portion 62. When the carrier 3 moves down, it will be limited by the bottom 102 of connector 1.

In practical situations, the side of carrier 3 close to the vertical side 103 of connector 1 is too close to the object connecting the connector 1, such as a wall or a large tree, so that birds can only fall in the carrier 3, left edge, right edge, or front edge of the carrier 3. Regardless of where birds fall on these parts, the force on carrier 3 can be decomposed into a horizontal force and a vertical downward force, enable the above-mentioned limiting assembly 6 and connector 1 to perfectly counteract the external force exerted by birds on the carrier 3, so that the carrier 3 will not be misaligned or detached from the connector 1 due to the influence of the force exerted by birds. When disassembling the carrier 3, simply lift the front side of the carrier 3 to remove it from the connector 1.

Furthermore, in order to facilitate the retrieval and placement of carrier 3, the third limiting portion 63 can be equipped with an arc-shaped extension plate.

Furthermore, in order to make the connection between the carrier 3 and the connector 1 more secure, the first limiting portion 61 can also be designed as follows. Specifically, the thickness of the first limiting portion 61 gradually increases from one end away from connector 1 to one end close to connector 1, so that during the process of inserting the carrier 3 into the first limiting portion 61 through the limiting slot 7, the damping force received increases, thereby clamping the carrier 3 and the limiting slot 7 tightly.

Furthermore, in order to ensure the flatness of the surface of the detachable bird feeder, a groove corresponding to the connector 1 can be formed on the bottom outer surface of the carrier 3, so that the bottom of the carrier 3 is flush with the bottom 102 of the connector 1, and the rear side of the carrier 3 is flush with the front side of the connector 1, so that the rear side of the carrier 3 is flush with the rear side of the connector 1, which is more aesthetically pleasing while also restricting the movement of the carrier 3.

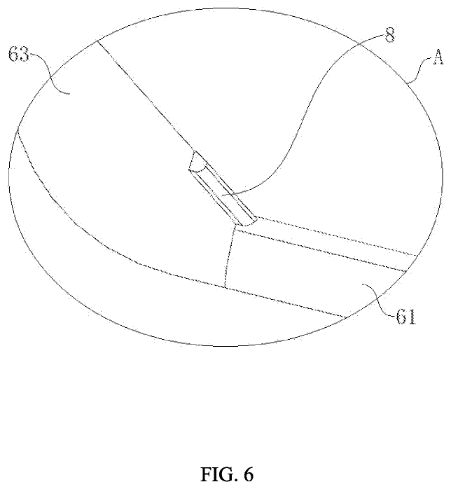

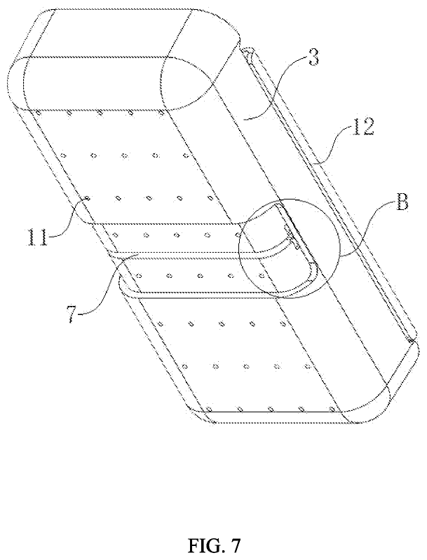

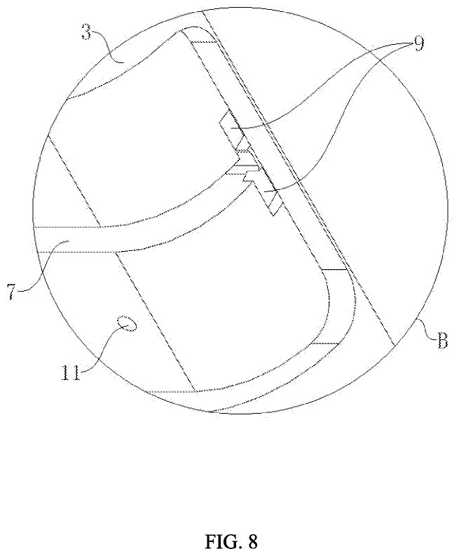

Referring to FIGS. 1 and 5-8, various accidents always occur in daily life, such as strong winds, birds grabbing upwards, human collisions, etc. Although these situations have a low probability of occurrence, they still affect the stability of the carrier 3. In order to ensure that the carrier 3 does not misalign or detach from the connector 1 when subjected to upward force, the following design is carried out in this embodiment. Specifically, there is a snapping joint 8 formed on the third limiting portion 63, and on the carrier 3, there is a corresponding snapping slot 9 for the snapping joint 8. At least one of the third limiting portion 63, snapping joint 8, carrier 3, and snapping slot 9 has elasticity, so that the third limiting portion 63 and the carrier 3 can be connected by the coordination of snapping joint 8 and snapping slot 9.

The bottom of snapping joint 8 and snapping slot 9 are both horizontally arranged, so that when the carrier 3 is subjected to upward force, it will not be misaligned or detached from connector 1. Specially, when the carrier 3 is lifted upwards, the plane at the bottom of the snapping slot 9 will touch the plane at the bottom of the snapping joint 8, thereby restricting the upward movement of the carrier 3, so that the carrier 3 can only be disassembled and assembled with the connector 1 through the deformation of the third limiting portion 63, the snapping joint 8, the carrier 3, or the snapping slot 9.

Furthermore, the positions of the snapping joint 8 and the snapping slot 9 can be interchanged. The difference between this scheme and the above scheme is that the top of the snapping joint 8 and the snapping slot 9 are both horizontally arranged, and the upward movement of the carrier 3 can also be restricted.

Referring to FIG. 1, in order to enrich the functions of the carrier 3, the following design has been carried out in this embodiment. Specifically, the carrier 3 is equipped with a partition plate 10 to divide it into multiple areas.

Through the design of the above structure, different foods can be placed in multiple areas to enrich the diet and intake of nutrients for birds. Drinking water can also be placed for birds to drink, or nothing can be placed as a resting area for birds to use.

Referring to FIG. 2, some food may spoil due to factors such as lack of air circulation at the bottom of carrier 3 and bird urine after being left for too long. To solve the above problems, the following design is carried out in this embodiment, specifically, the bottom of carrier 3 is equipped with multiple through holes 11, which circulate with external air and are used to discharge liquid.

Through the design of the above structure, liquids such as rainwater and bird urine can be quickly discharged from the carrier 3, and the food in the carrier 3 can also be kept in a dry state and not easily spoiled.

Referring to FIGS. 9 and 10, the length of the carrier 3 is less than or substantially equal to the height of the vertical side 103 of the connector 1. In this way, the vertical side 103 of the disassembled connector 1 can be horizontally placed and wrapped around the outside of the carrier 3, saving the space enclosed by the top 101, bottom 102, and vertical side 103 of connector 1. When stored, it is more compact and saves storage space. During mass production, it is convenient to stack the entire detachable bird feeder, as shown in FIG. 11.

Referring to FIG. 1, further, in order to facilitate the retrieval and placement of the carrier 3, an edge handle 12 can be arranged on the carrier 3 away from the side of the vertical side 103 the connector 1.

It should be noted that the terms used here are only for describing specific embodiments, and are not intended to limit exemplary embodiments according to this application. As used here, unless otherwise explicitly stated in the context, the singular form is also intended to include the plural form. In addition, it should be understood that when the terms including and/or including are used in this specification, they indicate the existence of features, steps, operations, devices, components, and/or their combinations.

In addition, it should be noted that the use of words such as first and second to define components is only for the purpose of distinguishing the corresponding components. Unless otherwise stated, the above words have no special meaning and cannot be understood as limiting the scope of protection of this application.

Although embodiments of the present invention have been shown and described, it can be understood by those skilled in the art that multiple variations, modifications, substitutions, and variations can be made to these embodiments without departing from the principles and spirit of the present invention. The scope of the present invention is limited by the accompanying claims and their equivalents.

What is claimed is:

1. A detachable bird feeder, comprising:
a substantially U-shaped connector, the connector comprising opposite horizontal sides and a vertical side connecting the horizontal sides, the horizontal sides serving as a top and a bottom of the connector respectively, the vertical side is used for supporting and fixing;
a shading assembly; and
a carrier for carrying the bird and feeding the bird;
the detachable bird feeder comprising a first state for unfolding and a second state for storage, in the first state, the shielding assembly and the carrier being respectively connected to the top and the bottom of the connector, and an open space being maintained between the shielding assembly and the carrier; in the second state, the shielding assembly and the carrier both being detached from the connector and stacked with the connector.

2. The detachable bird feeder according to claim 1, wherein the vertical side is equipped with multiple connecting parts including gourd holes with upper dimensions smaller than lower dimensions, and being used for connecting other objects.

3. The detachable bird feeder according to claim 2, wherein the top of the connector is equipped with two opposite slots, and the shielding assembly comprises:
two connecting portions respectively connected in the two slots with damping sliding, so that the relative positions of the connecting portions and the connector are fixed without external force; and
two covers fixedly connected to the two connecting portions and extending in a direction away from the slots, so that the two covers can form an eaves shape when matched with the top of the connector, thereby shielding the carrier.

4. The detachable bird feeder according to claim 3, wherein the slot is located at the top of the connector, and extends from one end away from the vertical side of the connector at the top to one end close to the vertical side of the connector, one end of the slot has an opening located on the vertical side of the connector and is used in conjunction with an object for fixing the connector to restrict the connecting portions within the slot.

5. The detachable bird feeder according to claim 3, wherein at least one of the connecting portions and the connector have elasticity, and one side of the connecting portions is bent into a V-shape, the thickness of the V-shaped part of the connecting portions gradually increases from the insertion end to the opposite end, so that the resistance generated by the connecting portions during insertion into the slot gradually increases, thereby clamping the connecting portions and the connector tightly.

6. The detachable bird feeder according to claim 2, further comprising a limiting assembly, the limiting assembly is formed on the connector, the bottom of the carrier is equipped with a limiting slot, the limiting assembly is matched with the limiting slot to limit the movement of the carrier, thereby fixing the relative position between the connector and the carrier.

7. The detachable bird feeder according to claim 6, wherein the limiting assembly comprises:
a first limiting portion, the first limiting portion is located at the bottom of the connector and is vertically arranged, the first limiting portion is connected to the limiting slot with a damping sliding connection to limit the movement of the carrier;
a second limiting portion, the second limiting portion is located on the vertical side of the connector and is horizontally arranged, a distance between the second limiting portion and the bottom of the connector is the same as the thickness of the carrier, preventing the carrier from tilting or overturning when subjected to downward force; and
a third limiting portion, the third limiting portion is located at a front end of the bottom of the connector and corresponds to the carrier, the third limiting portion is configured for limiting the forward movement of the carrier;
the first limiting portion, the second limiting portion, and the third limiting portion in a combination can prevent the carrier from being misaligned or detached from the connector when subjected to downward force.

8. The detachable bird feeder according to claim 6, wherein the third limiting portion is equipped with a snapping joint, and the carrier is equipped with a corresponding snapping slot, at least one of the third limiting portion, the snapping joint, the carrier, and the snapping slot is elastic, so that the third limiting portion and the carrier can be elastically connected by the combination of the snapping joint and the snapping slot for buckle connection, the bottom of the snapping joint and the snapping slot are both horizontally arranged, to ensure that the carrier does not misalign or detach from the connector when subjected to upward force.

9. The detachable bird feeder according to claim 1, wherein the carrier is equipped with a partition plate to divide the carrier into multiple areas.

10. The detachable bird feeder according to claim 1, wherein the bottom of the carrier is equipped with multiple through holes, which circulate with the external air and are used to discharge liquid.

11. The detachable bird feeder according to claim 1, wherein a length of the carrier is less than or substantially equal to a height of the vertical side of the connector.
